(19) United States
(12) Patent Application Publication
(10) Pub. No.: US 2002/0003776 A1
(43) Pub. Date: Jan. 10, 2002

(54) Interworking unit for integrating terrestrial ATM switches with broadband satellite networks

(76) Inventors: Dilip S. Gokhale, Montgomery Village, MD (US); Udayan N. Borkar, Fairfax, VA (US); Radhakrishnan Haridasan, Germantown, VA (US)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/844,075

(22) Filed: Apr. 30, 2001

Related U.S. Application Data
(60) Provisional application No. 60/200,223, filed on Apr. 28, 2000.

(51) Int. Cl. H04L 12/56; H04J 3/22

(52) U.S. Cl. 370/236; 370/395.51; 370/467; 370/319; 370/401

(57) ABSTRACT

A Terrestrial Satellite Interworking Unit (TSIU) is provided for achieving seamless integration of a terrestrial ATM network with a satellite ATM network. In particular, the TSIU in incorporated within a gateway for interconnecting a COTS ATM switch communicably linked to the terrestrial ATM network and a satellite modem communicably linked to the satellite ATM network. The TSIU provides traffic and resource management functions (such as DAMA, congestion control, and jitter removal), signaling interworking functions, and satellite domain-specific functions (such as data encryption/decryption, control channel ciphering, and gateway authentication).

### FIELD OF THE INVENTION

The present invention relates to an interworking unit for integration between a terrestrial communication network and a satellite communication network. In particular, the present invention relates to an interworking unit for a network node or gateway that interconnects a satellite network with terrestrial network for seamless integration of congestion control, Demand-Assigned Multiple Access (DAMA), Cell Delay Variation (CDV), data encryption, and signaling interworking.

### BACKGROUND OF THE INVENTION

Asynchronous Transfer Mode (ATM) is commonly used for implementing terrestrial broadband networks, which are designed to simultaneously transport various types of application traffic such as video, voice, and/or data. Future satellite systems are foreseen as being complimentary to terrestrial broadband networks in extending coverage to remote users. Several of these systems are being designed to provide ATM functionalities such as a connection-oriented approach and quality of service (QoS) characteristics to the end-user. Broadband satellite systems are currently being designed using a new generation of satellites with advanced onboard processing capabilities. In these systems, the satellite payload or onboard systems perform multiplexing, demultiplexing, channel coding/decoding, and fast packet switching while using multiple spot beams. The onboard processor in such systems functions as an “ATM switch in the sky”. However, this ATM switch function of the satellite systems differs from its terrestrial counterpart.

Architecturally, the onboard processor of the satellite includes a collapsed core portion of the satellite network and is, therefore, required to switch an extremely large number of virtual connections (VCs) in order to provide mesh connectivity. Further, implementing such a switch requires complex hardware. At the same time, this switch is expected to operate in a radiation-hardened environment with stringent restrictions on size, mass, and power. Consequently, satellite ATM switches tend to be less capable than terrestrial commercial off-the-shelf (COTS) ATM switches. For example, VC-based queuing can be employed in terrestrial switches, whereas satellite switches may support only class-of-service (COS)-based queuing.

In addition to the difference in switching capabilities, satellite ATM networks differ from terrestrial ATM networks in other ways because satellite networks are designed with special regard to issues that arise from the domain-specific characteristics of the satellite medium. For example, the fact that an onboard switch may not perform per-VC queuing makes it necessary to implement satellite-specific congestion control schemes. Furthermore, the requirement to share bandwidth and the ability to dynamically allocate bandwidth by implementing a Demand-Assigned Multiple Access (DAMA) or bandwidth-on-demand mechanism, result in schemes that allocate bandwidth based on fairness among uplink and/or downlink queues that are specific to each satellite network. The use of Time-Division Multiple Access (TDMA) technology for multiple access results in large cell delay variation (CDVs) or jitter that exceed the tolerance levels of terrestrial ATM switches. Further, the use of a shared radio medium necessitates protection of over-the-air data through the use of data encryption and ciphering of the signaling information exchange, which in turn leads to the need to support key distribution and authentication mechanisms.

At the same time, the use of COTS switching solutions at the network nodes or gateways which interconnect satellite networks with terrestrial networks is highly desirable in gateways in order to reduce cost and ensure seamless evolution, compatibility with the terrestrial network infrastructure, and compatibility with evolving standards. Consequently, at these gateways there is a problem in integrating generic COTS terrestrial broadband ATM switches with satellite systems that are designed around realm-specific and network-specific features. Presently, there is no known system that addresses these system integration issues at the satellite-terrestrial interface.

As discussed above, broadband satellite networks with onboard switching capabilities are expected to extend the reach of terrestrial broadband networks. However, the disparity in approaches between the terrestrial and satellite networks in areas such as traffic and resource management makes system integration difficult. Accordingly, it is an object of the present invention to provide a Terrestrial Satellite Interworking Unit (TSIU) that can achieve seamless integration of COTS ATM switches with broadband satellite networks. The TSIU design, described herein, provides for congestion control, Demand-Assigned Multiple Access (DAMA), CDV (or jitter) reduction, data encryption, and signaling interworking.

### SUMMARY OF THE INVENTION

According to the present invention, a Terrestrial Satellite Interworking Unit (TSIU) is provided at a gateway for interconnecting a COTS ATM switch communicably linked to a terrestrial ATM network and a satellite modem communicably linked to a satellite ATM network and achieving seamless integration between the terrestrial ATM network and the satellite ATM network by providing traffic and resource management functions, signaling interworking functions, and satellite domain-specific functions.

The TSIU provides congestion control at the gateway via a congestion control unit for regulating a rate of transmission of data to each satellite downlink beam based on congestion messages from the satellite network and traffic scheduler for implementing class-based queuing and scheduling for each downlink beam. By buffering or discarding cells at the ground, rather than at the satellite payload, the TSIU significantly improves utilization of uplink bandwidth by transmitting cells destined for other beams. Further, the TSIU can also implement appropriate backpressure toward the ATM switch and the end-user.

The TSIU implements DAMA at the gateway via a DAMA unit which monitors traffic from the ATM switch and issues bandwidth requests to a Network Control Center (NCC). The NCC receives these requests, performs fair bandwidth allocation across gateways, and sends updated bandwidth allocations to the DAMA unit of the TSIU at each gateway. Upon receiving these allocations, the DAMA unit adjusts the bandwidth at both the satellite modem interface and the ATM switch interface.

The TSIU reduces cell delay variation on incoming data from the satellite network by shaping data traffic received from the satellite network. A cell delay variation removal unit of the TSIU shapes data traffic based on parameters for each ATM virtual connection which are obtained by intercepting a virtual connection traffic descriptor which is exchanged between the ATM switch of the gateway and the NCC during call setup.

The TSIU includes a data encryption and decryption unit for performing encryption of data received from the terrestrial network, and decryption of received data from the satellite network, using a satellite-network-specific encryption scheme transparent to the ATM switch of the gateway. The a data encryption and decryption unit obtains key information for data security by intercepting call signaling information exchanged during call setup between the ATM switch of the gateway and a Network Control Center.

The TSIU includes a signal interworking unit for providing signaling interworking between a signaling protocol of the terrestrial and a signaling protocol of satellite networks. In particular, the signal interworking unit provides interworking between terrestrial network signaling protocols and satellite network signaling protocols.

### BRIEF DESCRIPTION OF THE DRAWINGS

These and other features, aspects and advantages of the present invention will become better understood with reference to the following detailed description, appended claims, and accompanying drawings, wherein:

FIG. 1 illustrates a broadband satellite network;

FIG. 2 illustrates the architecture of a gateway including the terrestrial satellite interworking unit of the present invention;

FIG. 3. illustrates the architecture for implementing congestion control within the terrestrial satellite interworking unit in accordance with a first embodiment of the present invention;

FIG. 4 illustrates the architecture for implementing DAMA within the terrestrial satellite interworking unit in accordance with a second embodiment of the present invention;

FIG. 5 is a block diagram illustrating jitter removal within the gateway in accordance with a third embodiment of the present invention;

FIG. 6 illustrates the architecture for implementing data encryption and decryption within the terrestrial satellite interworking unit in accordance with a fourth embodiment of the present invention;

FIG. 7 illustrates signaling stack implementation within the terrestrial satellite interworking unit in accordance with a fifth embodiment of the present invention; and

FIG. 8 illustrates an example signaling stack implementation within the terrestrial satellite interworking unit in accordance with a fifth embodiment of the present invention.

### DESCRIPTION OF THE PREFERRED EMBODIMENTS

As shown in FIG. 1, a terrestrial-satellite broadband ATM-based network employing the present invention includes a satellite 1 communicably linked to a Network Control Center (NCC) 5 , a plurality of terrestrial ATM networks 2, and a plurality of user terminals 6. A plurality of gateways 3 serve as points of interconnection between the satellite 1 and the terrestrial networks 2. The satellite 1 includes an onboard payload switch (not shown) which provides the necessary connectivity among the gateways 3 and terminals 6, as well as with the NCC 5 for signaling and management purposes. The NCC 5 is responsible for managing network resources, such as system bandwidth, and the payload switch. In particular, the NCC 5 allocates bandwidth to the gateways 3 and terminals 6 on demand, based on the current traffic carried by each gateway 3. Further, the NCC 5 establishes and terminates the connections at the onboard payload switch of the satellite 1 to support unicast and multicast calls.

As shown in FIG. 2, the gateway 3 comprises a COTS ATM switch 10 that provides the necessary interface with the terrestrial ATM network 2, a satellite modem 30 for communicating with the satellite 1, and a TSIU 20 for interconnecting the COTS ATM switch 10 and the satellite modem 30. The COTS ATM switch 10 maps incoming ATM cells to a plurality of outgoing queues, based on information contained in the header portion of the ATM cells. The satellite modem 30 performs two functions—modulation and demodulation. In the to-satellite direction, the satellite modem 30 modulates a carrier(s) based on an incoming bit stream. In the to-terrestrial direction, the satellite modem 30 recovers a bit stream by demodulating a carrier. The gateway 3 is designed to seamlessly integrate the terrestrial segment with the satellite segment in a hybrid broadband ATM-based network, while taking into account the domain-specific capabilities and limitations of each segment. The TSIU 20 provides for traffic and resource management functions (such as DAMA, congestion control, and jitter removal), signaling interworking functions, and satellite domain-specific functions (such as data encryption/decryption, control channel ciphering, and gateway authentication). The TSIU 20 of the present invention allows utilization of a wide array of protocol interworking support characteristics of COTS ATM switches, while simultaneously supporting specific techniques used over the satellite segment. The individual features of the TSIU 20 will be described in detail.

For the reasons identified above, broadband satellite networks implement nonstandard (typically proprietary) congestion control schemes. In a terrestrial network, the COTS ATM switch 10 is designed to implement congestion control for available-bit-rate (ABR)-type traffic using per-VC monitoring and rate control. However, this scheme is difficult to implement within the payload switch of the satellite 1 due to the extremely large number of VCs that pass through the collapsed core of the satellite network. This lack of per-VC queuing can lead to unfair allocation and uneven delay throughput performance within the satellite network. Further, associated packet discard schemes that work on a per-VC basis, such as Partial Packet Discard (PPD), cannot be implemented. On the other hand, the COTS ATM switch 10 interfaces with the satellite network via a single interface and cannot be expected to recognize congestion occurring on specific downlink beams at the payload switch of the satellite 1. However, at times of congestion, it is preferable to selectively drop or buffer those packets on the ground which will traverse congested downlink beams. In accordance with the preferred embodiment of the present invention, the TSIU 20 provides congestion control at the gateway 3 and seamlessly integrates with the COTS ATM switch 10.

As shown in FIG. 3, the TSIU 20 includes a congestion control unit 21 and traffic scheduler 22 for implementing class-based queuing and scheduling for each downlink beam. Traffic received from the COTS ATM switch 10 is directed to the appropriate queue for the appropriate downlink beam wherein a plurality of queues 23 are provided on a one-to-one basis for the downlink beams. The traffic scheduler 22 periodically checks the size of the downlink queues 23, the total bandwidth available, and the traffic contracts of each VC, in order to schedule cells for transmission from each queue.

Upon experiencing congestion in a specific downlink, the NCC 5 or payload (onboard processor) of the satellite 1 broadcasts a congestion indication message to the entire network via the satellite. The congestion control unit 21 of the TSIU 20 receives the congestion indication message and requests the traffic scheduler 22 to further reduce excess traffic to the specified downlink beam. When congestion abates, the traffic to the downlink beam is slowly increased (e.g., in response to receiving another congestion indication message or by incrementally increasing traffic at specified time intervals).

Multicast traffic at each gateway 3 may be directed to a separate multicast queue, wherein the multicast traffic will be given higher priority by the traffic scheduler 22. Since multicast traffic is directed at a number of downlink beams, congestion in one downlink beam should not cause a backoff of multicast traffic to all other downlink beams. As a result, quality of service is maximized for real-time video, audio, and other multimedia applications.

In accordance with the preferred embodiment of the present invention, the congestion control implementation at the gateway uses a two-step traffic management approach. The COTS ATM switch 10 provides scheduling based on the type of traffic, priority, application information, as well as other considerations. In particular, the COTS ATM switch 10 performs most of the popular conventional packet and cell discard policies, including Early Packet Discard (EPD), PPD and Random Early Discard (RED), and generates traffic at a rate close to the current uplink bandwidth to the TSIU 20. The TSIU 20 then performs scheduling on a per-downlink-beam basis. By buffering or discarding cells at the ground, rather than at the satellite payload, the TSIU 20 significantly improves utilization of uplink bandwidth by transmitting cells destined for other beams. The use of a distributed algorithm imposes a smaller processing load on both the gateway 3 and the NCC 5, and permits a faster response. While the TSIU 20 implements satellite-network-specific congestion control in the manner described above, the TSIU 20 can also implement appropriate backpressure toward the ATM switch 10 and the end-user. For example, the TSIU 20 can map the satellite-specific congestion control to the rate controls provided by ABR traffic class VCs. Similarly, the TSIU 20 can set the proposed explicit congestion notification (ECN) bit in IP packets transported in ATM VCs destined to congested satellite downlink beams. Finally, by intercepting the packets at the TCP layer (only applicable to non-secure IP flows), the TSIU 20 can modify the advertised receive window in accordance with the congestion conditions at the gateway 3.

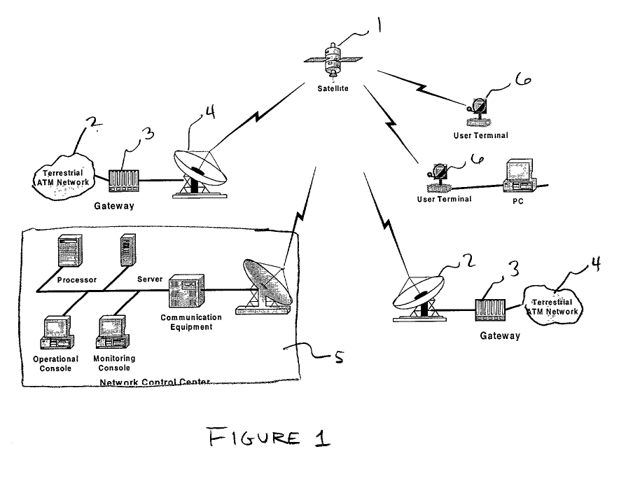

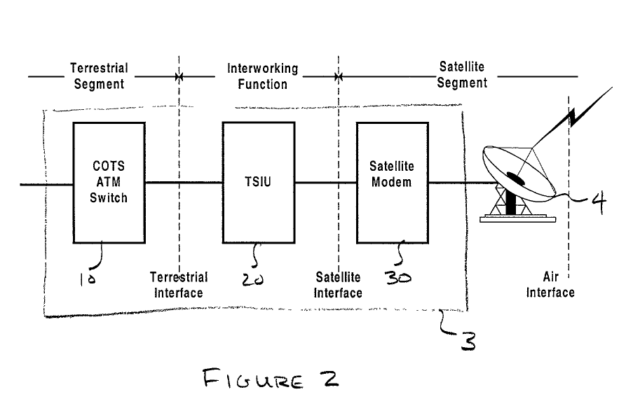

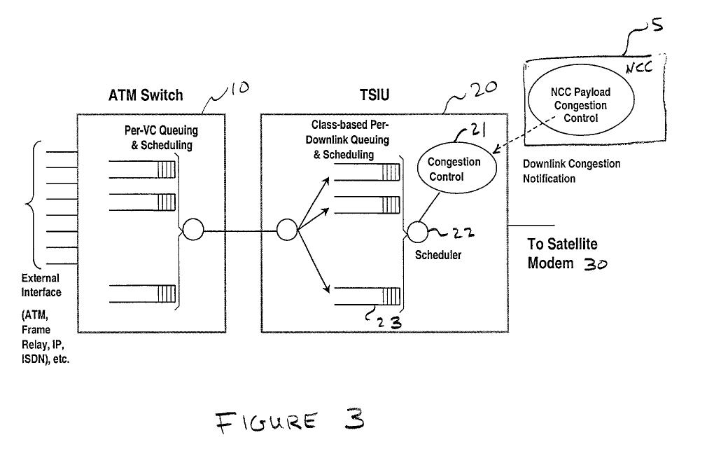

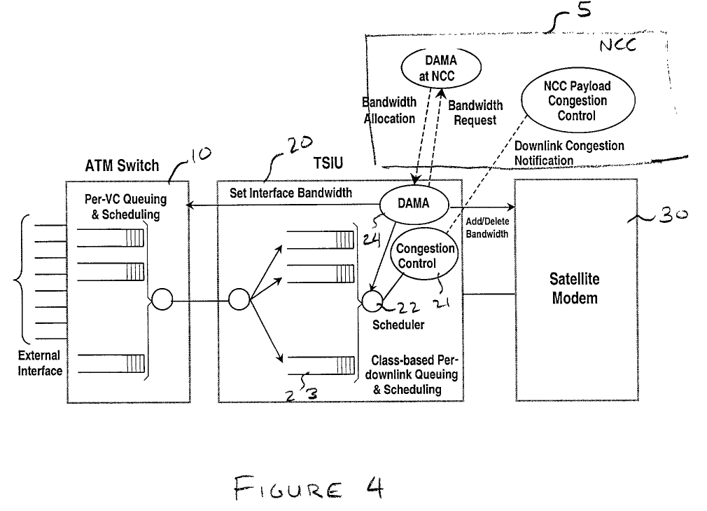

A second feature of the preferred embodiment of the present invention will now be described with reference to FIG. 4. DAMA is employed in satellite networks for the efficient utilization of shared satellite resources. The NCC 5 employs DAMA to allocate bandwidth across multiple gateways, based on the current traffic reported at each gateway. The COTS ATM switch 10, on the other hand, is designed to work with fixed “traffic-engineered” links at fixed data rates (e.g., 155 Mb/s and 45 Mb/s). In accordance with the second preferred embodiment of the present invention, the TSIU 20 performs an important role in interworking DAMA capabilities with the COTS ATM switch 10.

As shown in FIG. 4, DAMA is implemented at the gateway via a DAMA unit 24 of the TSIU 20 which monitors traffic from the ATM switch 10 and issues bandwidth requests to the NCC 5. The NCC 5 receives these requests, performs fair bandwidth allocation across gateways 3 (taking into account the percentages of committed and excess traffic), and sends updated bandwidth allocations to the DAMA unit 24 of the TSIU 20 at each gateway 3. Upon receiving these allocations, the DAMA unit 23 of the TSIU 20 adjusts the bandwidth at both the satellite modem interface and the ATM switch interface. Bandwidth requests sent to the NCC 5, as well as the bandwidth allocations received from the NCC 5, are carried by the satellite modem 30 using in-band signaling. The interface bandwidth is set by using control commands or network management messages. As shown in FIG. 4, the DAMA capability is implemented within the TSIU 20 in an integrated manner with the satellite-specific congestion control algorithm.

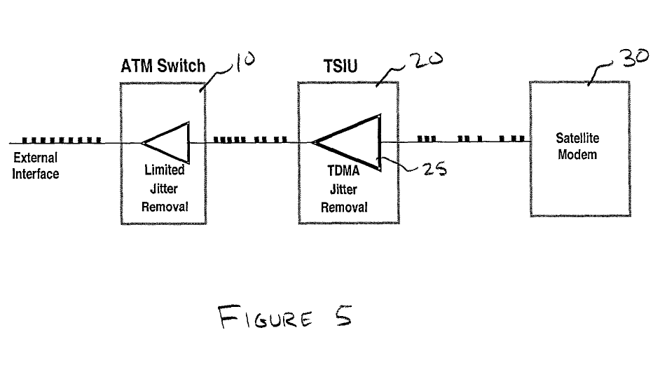

A third feature of the preferred embodiment of the present invention will now be described with reference to FIG. 5. COTS ATM switches are designed to compensate for CDV (jitter) encountered in terrestrial networks, typically on the order of a few milliseconds. The use of multiple-access schemes like TDMA potentially results in large jitter within the satellite segment (e.g., on the order of tens of milliseconds). However, COTS ATM switches are not designed to eliminate such large jitter.

ATM Forum specifications (e.g., Traffic Management Specification 4.1) restrict the maximum allowable CDV within the ATM network to 1.5 ms, and specify a maximum end-to-end CDV of 3.0 ms. The COTS ATM switch does not perform any traffic-shaping on incoming traffic from the satellite 1. Thus, there is a need to reconcile the cell delay expectation of terrestrial networks (and COTS ATM switches) with the CDV encountered in TDMA networks by compensating for the large variation in cell delay in the to-terrestrial direction.

As shown in FIG. 5, the traffic-shaping functionality of the TSIU 20 shapes traffic based on VC traffic contracts, for constant bit rate (CBR) and real-time variable bit rate (rt-VBR) traffic types, before delivery to the ATM switch 10. In addition to a baseline approach of buffering and re-timing cells, the TSIU 20 can also insert and remove special Operations, Administration, and Maintenance (OAM) cells with time stamps over the satellite link. This time stamp information is used for more accurate jitter removal, particularly for rt-VBR traffic. TDMA jitter removal is critical for applications such as video streaming, audio streaming, telephony, and videoconferencing that are expected to be used over the next generation of broadband networks.

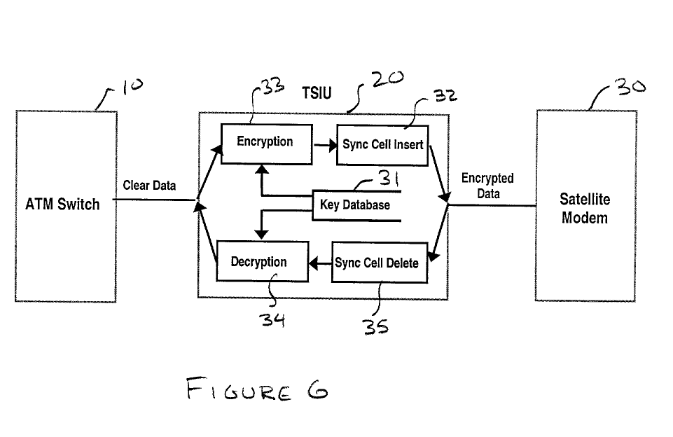

With reference to FIG. 6, a fourth feature of the preferred embodiment of the present invention will be described. Data confidentiality is an important domain-specific requirement of the satellite environment. Due to the shared nature of the radio medium, ATM cells carrying data traffic over the satellite segment are encrypted before the satellite modem 30 transmits them on the air interface. At the terrestrial interface, however, the COTS ATM switch 10 processes ATM cells in the clear (i.e., without encryption). The TSIU 20 allows the terrestrial and satellite segments to interoperate by acting as an intermediary. In the to-satellite direction, the TSIU performs encryption based on the specific requirements of the satellite system. Various encryption schemes, such as the Data Encryption Standard (DES) or triple-DES, may be used. In the to-terrestrial direction, the TSIU 20 performs decryption. Further, the TSIU 20 is cognizant of other satellite-specific requirements, such as the use of encryption/decryption keys on a per-VC basis, and beam-specific addressing of ATM cells, and may extract this information by intercepting the signaling exchanged between the NCC 5 and the gateway 3.

Data encryption is provided within the TSIU 20 by using an encryption algorithm, such as DES-56, at the ATM layer. Encryption/decryption support can be provided on a per-VC basis by intercepting the in-band signaling at the call control function and extracting encryption/decryption keys. Key distribution is performed at the start of each session and is cached within the TSIU for the duration of the session. By implementing satellite-specific requirements (in this case data cell encryption), the TSIU 20 allows the COTS switch 10 to be used at the gateway 3 without alteration. As shown in FIG. 6, in the to-satellite direction, ATM cells in the clear are encrypted by an encryption unit 33 using appropriate keys from a key database 31 followed by insertion of sync cells by a sync cell insertion unit 32. In the to-terrestrial direction, the corresponding inverse operation is performed in reverse order by a decryption unit 34, a sync cell deletion unit 35, and the key database 31.

For example, the TSIU 20 may provide data encryption/ decryption using the Advanced Encryption Standard (AES). The TSIU will acquire AES keys on a per VC basis by intercepting the Call Signaling. Keys are acquired at the time of Call Setup and retained by the TSIU for the duration of the call.

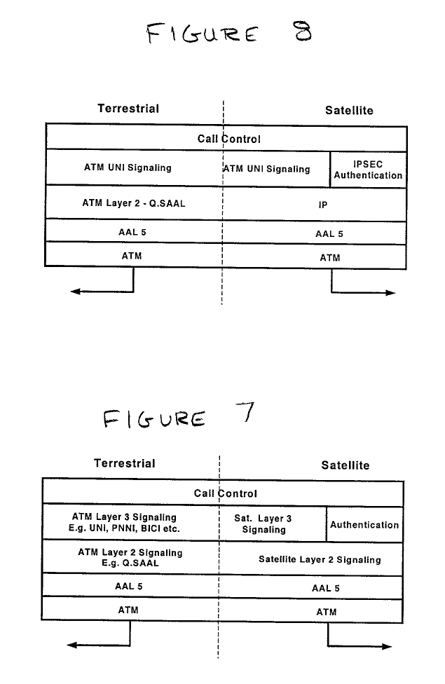

A fifth feature of the preferred embodiment of the present invention will be described with reference to FIG. 7. Call control signaling on the terrestrial side, within the COTS ATM switch 10, is performed using standard protocols such as User Network Interface (UNI), Private Network-to-Network Interface (PNNI), and Broadband Intercarrier Interface (BICI). As mentioned previously, the possibility of sharing bandwidth, the ability to implement bandwidth on demand, the need to support key distribution mechanisms, and the requirement to support mapping of satellite beams to VC identifiers results in satellite networks having unique signaling schemes that carry auxiliary information. The satellite network, given its “open” radio transmission mode, may also impose additional requirements for signaling channel data confidentiality and gateway authentication.

The TSIU 20 provides signaling interworking between COTS ATM protocol stacks and satellite signaling mechanisms by implementing both stacks. An example signaling stack implementation within the TSIU is shown in FIG. 7, wherein a Call Control layer is responsible for intercepting relevant information such as encryption/decryption keys, VC traffic contracts, and downlink and uplink beam information, as well as for interworking between the terrestrial and satellite signaling protocol stacks. Gateway authentication is provided by using protocols such as the GSM/GPRS A3 algorithm, or IP-based authentication schemes such as PAP, CHAP or IPSEC on the satellite side. Ciphering of signaling packets is supported using appropriate layer 2 protocols such as GSM/GPRS LLC, as defined in GSM 04.64.

For example as shown in FIG. 8, the TSIU 20 may implement the following signaling interworking stack. The Terrestrial Side stack implements ATM for the Physical and MAC layers. The AAL-5 protocol above the ATM layer will provide segmentation and re-assembly of packets into ATM cells. The Q.SAAL Protocol can provide reliable delivery of messages. UNI Signaling can be used at Layer 3 to signal ATM Call Setup, Teardown, etc. On the Satellite Side, UNI can be used to provide Call Signaling to the NCC. The ATM Q.SAAL protocol can be used at layer 2 to provide reliable delivery and can be used together with UDP/IPSEC to provide encryption of signaling data. The IPSEC Protocol can be used to provide authentication. AAL-5 and ATM can be used below IP as with the Terrestrial Side Signaling stack. The Call Control layer can provide the necessary interworking between the Terrestrial and Satellite Layers to provide call state management, intercept data encryption/decryption keys, extract information on ATM VC traffic contracts and provide it to the traffic scheduler within the TSIU.

Although certain preferred embodiments of the present invention have been described, the spirit and scope of the invention is by no means restricted to what is described above.

What is claimed is:

1. A communication system comprising:
a satellite communication network;
a terrestrial communication network; and
a gateway connecting said satellite communication network and said terrestrial communication network, said gateway comprising
an asynchronous transfer mode (ATM) switching unit for providing an interface with the terrestrial communication network;
a satellite modem for communicating with the satellite network; and
an interworking unit interposed between said switching unit and said satellite modem for providing seamless integration between the terrestrial communication network and the satellite communication network by providing traffic and resource management functions, signaling interworking functions, and satellite domain-specific functions.

2. The communication system according to claim 1, wherein said interworking unit comprises a congestion control unit for performing congestion control in the satellite network and back-pressuring terrestrial data traffic based on a current data traffic load in the satellite network.

3. The communication system according to claim 1, wherein said interworking unit comprises a demand-assigned multiple access (DAMA) control unit for allocating satellite bandwidth on demand to the gateway based on a current data traffic carried by the gateway.

5. The communication system according to claim 1, wherein said interworking unit comprises a cell delay variation removal unit for reducing cell delay variation on incoming data from the satellite network.

6. The communication system according to claim 1, wherein said interworking unit comprises a data encryption and decryption unit for performing encryption of data received from the terrestrial network, and decryption of received data from the satellite network.

7. The communication system according to claim 1, wherein said interworking unit comprises a signal interworking unit for providing signaling interworking between a signaling protocol of the terrestrial network and a signaling protocol of the satellite network.

8. An apparatus for performing interworking between an ATM switch and a satellite modem of a gateway interconnecting a terrestrial ATM network and a satellite ATM network, said ATM switch being communicably linked to said terrestrial ATM network and said satellite modem being communicably linked to said satellite ATM network, the apparatus comprising:
a. a congestion control unit for performing congestion control in the satellite network and back-pressuring terrestrial data traffic based on a current data traffic load in the satellite network;
b. a demand-assigned multiple access (DAMA) control unit for allocating satellite bandwidth on demand to the gateway based on a current data traffic carried by the gateway;
c. a cell delay variation removal unit for reducing cell delay variation on incoming data from the satellite network;
d. a data encryption and decryption unit for performing encryption of data received from the terrestrial network, and decryption of received data from the satellite network; and
e. a signal interworking unit for providing signaling interworking between a signaling protocol of the terrestrial network and a signaling protocol of the satellite network.

9. The apparatus defined in claim 8, wherein the congestion control unit receives congestion messages from the satellite network via the satellite modem and regulates a rate of transmission of data to each satellite downlink beam from the satellite network.

10. The apparatus defined in claim 8, further comprising
a plurality of queues for each downlink satellite beam for each ATM class of service or each ATM virtual connection, wherein said congestion control unit regulates the rate of transmission of data to each satellite downlink beam by queuing data traffic received from the ATM switch in a corresponding one of said queues or by queuing traffic for each ATM virtual connection in a corresponding one of said queues; and
a traffic scheduler for monitoring queued traffic, a negotiated traffic guarantee for each ATM virtual connection, current congestion in each satellite downlink beam, and the total bandwidth available for transmission of traffic to the satellite, determining the rate of transmission of data traffic to each satellite downlink beam, guaranteeing a minimum rate based on the ATM traffic contract, regulating the rate of flow of excess traffic, using a separate one of said queues for multicast traffic, and controlling the rate of transmission of multicast traffic based on overall satellite system load.

11. The apparatus defined in claim 8, wherein said congestion control unit regulates the flow of data traffic from the terrestrial network on a per-ATM virtual connection basis by using an Available Bit Rate (ABR) flow control mechanism.

12. The apparatus defined in claim 8, wherein said congestion control unit regulates the flow of data traffic from the terrestrial network by setting an Explicit Congestion Notification (ECN) bit in Internet Protocol (IP) data packets transported in ATM virtual connections destined to congested satellite downlink beams.

13. The apparatus defined in claim 8, wherein said congestion control unit regulates the flow of traffic by controlling an advertised receive window of TCP connections carried in ATM virtual connections destined to congested downlink beams.

14. The apparatus defined in claim 8, wherein said congestion control unit regulates the flow of traffic by a implementing packet discard scheme

15. The apparatus defined in claim 14, wherein said packet discard scheme includes Early Packet Discard (EPD), Partial Packet Discard (PPD) or Random Early Discard (RED).

16. The apparatus defined in claim 8, wherein said DAMA unit requests bandwidth from a Network Control Center which manages network resources based on the current data traffic load at the gateway, receives bandwidth allocations from the Network Control Center, and provides the bandwidth allocations to said traffic scheduler.

17. The apparatus defined in claim 16, wherein said DAMA unit informs the ATM switch of said gateway of bandwidth changes received from the Network Control Center so that the ATM switch limits the flow of data traffic to the satellite network, and informs the satellite modem of the allocated bandwidth so that the satellite modem transmits on correct radio frequencies at an appropriate time.

18. The apparatus defined in claim 8, wherein said cell delay variation removal unit reduces cell delay variation by shaping data traffic received from the satellite network.

19. The apparatus defined in claim 18, wherein said cell delay variation removal unit shapes data traffic based on parameters for each ATM virtual connection which are obtained by intercepting a virtual connection traffic descriptor which is exchanged between the ATM switch of the gateway and a Network Control Center during call setup.

20. The apparatus defined in claim 8, wherein said cell delay variation removal unit reduces cell delay variation by introducing special Operations, Administration, and Maintenance (OAM) cells containing time stamps and using the time stamps to determine a time of arrival of ATM cells at the gateway.

21. The apparatus defined in claim 8, wherein said a data encryption and decryption unit performs data encryption of data to be transmitted to the satellite system and decryption of data received from the satellite system, using a satellite-network-specific encryption scheme transparent to the ATM switch of the gateway.

22. The apparatus defined in claim 21, wherein said a data encryption and decryption unit obtains key information for data security by intercepting call signaling information exchanged during call setup between the ATM switch of the gateway and a Network Control Center.

23. The apparatus defined in claim 8, wherein said signal interworking unit provides interworking between terrestrial network signaling protocols and satellite network signaling protocols.

24. The apparatus defined in claim 8, wherein signal interworking unit performs ciphering of signaling data within the satellite network.

25. The apparatus defined in claim 8, wherein signal interworking unit provides authentication of the gateway within the satellite network.
